(19) United States
(12) Patent Application Publication
(10) Pub. No.: US 2023/0147271 A1
(43) Pub. Date: May 11, 2023

(54) BUFFER MATERIAL

(71) Applicant: SEIKO EPSON CORPORATION, Tokyo (JP)

(72) Inventors: Jun TAKIZAWA, Chino (JP); Tetsuji FUJITA, Chino (JP); Tomoaki NAKAMURA, Shiojiri (JP); Hisashi KOIKE, Suwa (JP)

(21) Appl. No.: 18/052,954

(22) Filed: Nov. 7, 2022

(30) Foreign Application Priority Data
Nov. 8, 2021 (JP) 2021-181858

(51) Int. Cl. B31F 1/22; B31D 1/00

(52) U.S. Cl. CPC B31F 1/225; B31D 1/0093

(57) ABSTRACT

A buffer material of the present disclosure is a buffer material including a buffer sheet that contains cellulose fibers and a binding material binding the cellulose fibers and has a sheet shape, in which the buffer sheet has a plurality of first projections that protrude toward at least one surface side and are provided in a lattice shape. Further, it is preferable that the buffer sheet further have a plurality of second projections having a projection amount that is greater than a projection amount of the first projections.

The present application is based on, and claims priority from JP Application Serial Number 2021-181858, filed November 8, 2021, the disclosure of which is hereby incorporated by reference herein in its entirety.

### BACKGROUND

### 1. Technical Field

The present disclosure relates to a buffer material.

### 2. Related Art

In recent years, there has been a demand for a buffer material with a reduced environmental load in place of plastic materials. In the related art, a processing method of reusing used paper has been known. For example, JP-A-2013-199325 discloses a buffer material formed of crepe paper. The crepe paper is obtained by performing a process of forming wrinkles on base paper, which is formed by recycling used paper, and hardening the wrinkles with, for example, a shape retention agent, and has a property of expanding and contracting in a direction intersecting the wrinkles. Such a buffer material has a wavy sheet shape and is used by wrapping an object to be protected according to the size of a packing material.

However, since the buffer material described in JP-A-2013-199325 has a wavy shape, the buffer material can be easily deformed by, for example, forming a fold in a direction in which the wavy shape is repeated or being rolled in the direction thereof, but the buffer material is difficult to deform in a direction different from the direction described above. Therefore, the direction during deformation is limited.

### SUMMARY

According to an aspect of the present disclosure, there is provided a buffer material including a buffer sheet that contains cellulose fibers and a binding material binding the cellulose fibers and has a sheet shape, in which the buffer sheet has a plurality of first projections that protrude toward at least one surface side and are provided in a lattice shape.

### BRIEF DESCRIPTION OF THE DRAWINGS

FIG. 1 is a view schematically showing an example of a production device capable of producing a buffer material of the present disclosure.

FIG. 2 is an enlarged cross-sectional view showing a buffer material (first embodiment) of the present disclosure.

FIG. 3 is an enlarged plan view showing the buffer material (first embodiment) of the present disclosure.

FIG. 4 is a cross-sectional view showing a buffer material (second embodiment) of the present disclosure.

### DESCRIPTION OF EXEMPLARY EMBODIMENTS

Hereinafter, preferred embodiments of the present disclosure will be described in detail.

### First Embodiment

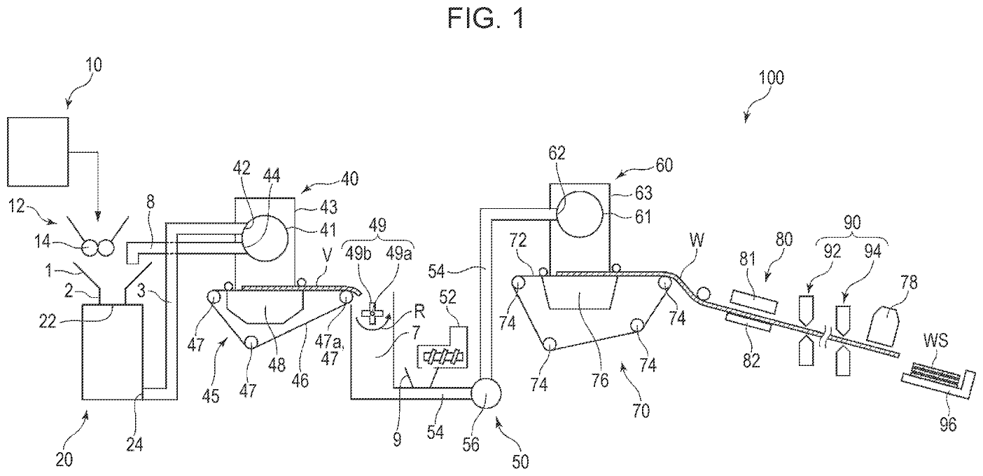

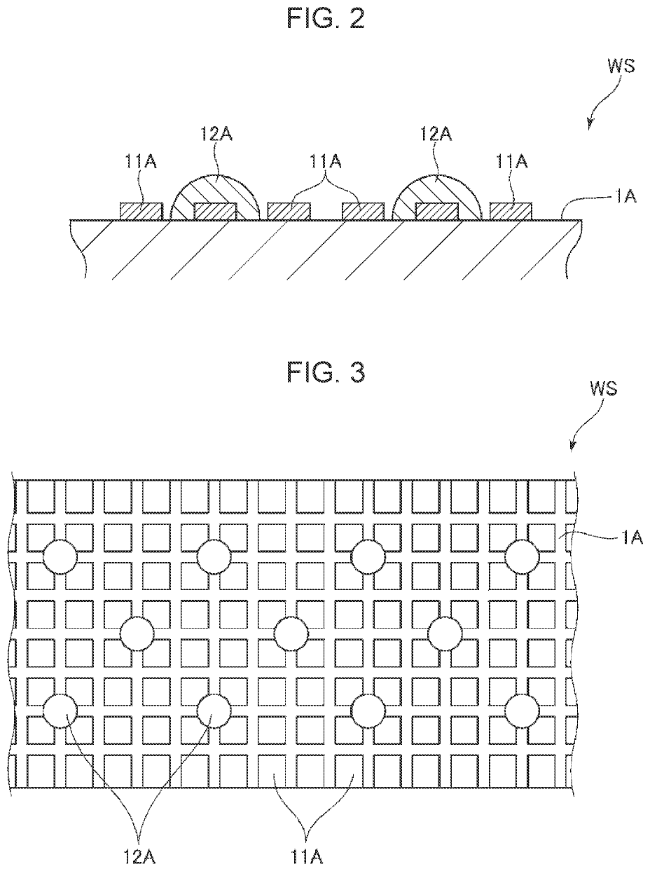

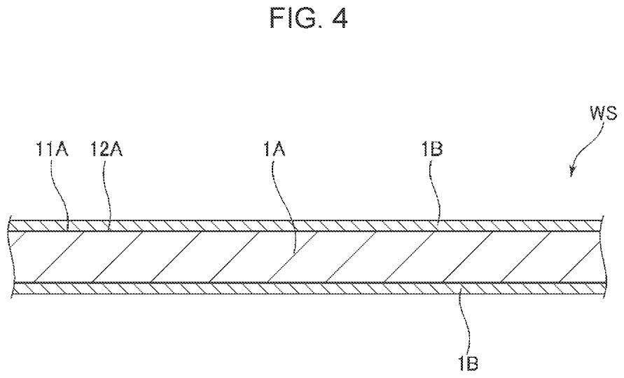

FIG. 1 is a view schematically showing an example of a production device capable of producing a buffer material of the present disclosure. FIG. 2 is an enlarged cross-sectional view showing a buffer material of the present disclosure. FIG. 3 is an enlarged plan view showing the buffer material of the present disclosure. Hereinafter, for convenience of description, the upper side in FIGS. 1 and 2 (the same also applies to FIG. 4) will be referred to as “upside” and the lower side therein will be referred to as “downside”.

Examples of the present disclosure will be described in the embodiments described below. The present disclosure is not limited to the following embodiments and include various modifications within a range not departing from the scope of the present disclosure. Further, configurations described below may not all necessarily be essential configurations.

First, a buffer material will be described.

A buffer material WS of the present embodiment includes a buffer sheet 1A. The buffer sheet 1A contains a plurality of cellulose fibers and a binding material that binds the cellulose fibers.

The cellulose fibers are an abundant natural material derived from a plant, and it is preferable that the cellulose fibers be used as fibers from the viewpoints of suitably dealing with the environmental problems, saving reserve resources, stably supplying the buffer material WS, reducing the cost, and the like. Further, the cellulose fibers have a particularly high theoretical strength among various fibers and are also advantageous from the viewpoint of improving the strength of the buffer material.

Typically, cellulose fibers are mainly formed of cellulose, but may contain components other than cellulose. Examples of such components include hemicelluloses and lignin.

Here, the content of lignin in the cellulose fibers is preferably 5.0% by mass or less, more preferably 3.0% by mass or less, and still more preferably 1.0% by mass or less.

In this manner, buffering performance, particularly compression characteristics, of the buffer material WS is further improved.

The content of the cellulose in the cellulose fibers is preferably 50.0% by mass or greater, more preferably 60.0% by mass or greater, and still more preferably 80.0% by mass or greater.

For example, fibers which have been subjected to a bleaching treatment or the like may be used as the cellulose fibers. Further, the cellulose fibers may have been subjected to a treatment such as an ultraviolet irradiation treatment, an ozone treatment, or a plasma treatment.

As the cellulose fibers, chemical cellulose fibers such as organic cellulose fibers, inorganic cellulose fibers, and organic-inorganic composite cellulose fibers may be used in addition to the natural cellulose fibers such as animal cellulose fibers and plant cellulose fibers. More specifically, examples of the cellulose fibers include cellulose fibers consisting of cellulose, cotton, cannabis, kenaf, linen, ramie, jute, manila hemp, sisal hemp, conifer, and hardwood. These cellulose fibers may be used alone or in the form of a mixture as appropriate, or may be used as regenerated cellulose fibers which have been purified or the like. Further, the cellulose fibers may be subjected to various surface treatments.

The average length of the cellulose fibers is not particularly limited, but is preferably 10 μm or greater and 50 mm or less, more preferably 20 μm or greater and 5.0 mm or less, and still more preferably 30 μm or greater and 3.0 mm or less in terms of the length-length weighted average cellulose fiber length.

In this manner, the stability of the shape of the buffer material WS, the strength of the buffer material, and the like can be further improved. Further, the buffering performance of the buffer material WS can be further improved.

When the cellulose fibers contained in the buffer sheet 1A are considered to be one independent cellulose fiber, the average thickness thereof is preferably 1.0 μm or greater and 1000 μm or less and more preferably 2.0 μm or greater and 100.0 μm or less.

In this manner, the stability of the shape of the buffer material WS, the strength of the buffer material, and the like can be further improved. Further, the buffering performance of the buffer material WS can be further improved. Further, it is possible to more effectively prevent the surface of the buffer material WS from being unexpectedly uneven.

Further, when a cross section of the cellulose fiber is not circular, a circle having the same area as the area of the cross section is assumed, and the diameter of the circle is used as the thickness of the cellulose fiber.

The average aspect ratio of the cellulose fibers, that is, the average length with respect to the average thickness thereof is not particularly limited, but is preferably 10 or greater and 1000 or less and more preferably 15 or greater and 500 or less.

In this manner, the stability of the shape of the buffer material WS, the strength of the buffer material, and the like can be further improved. Further, the buffering performance of the buffer material WS can be further improved. Further, it is possible to more effectively prevent the surface of the buffer material WS from being unexpectedly uneven.

In the present specification, the term “cellulose fibers” denotes a single cellulose fiber or an aggregate of a plurality of cellulose fibers. Further, the cellulose fibers may be cellulose fibers loosened into fibers by performing a defibration treatment on a material to be defibrated, that is, a defibrated material. Examples of the material to be defibrated here include cellulose fibers obtained by being entangled or bound, such as pulp sheets, paper, used paper, tissue paper, kitchen paper, cleaners, filters, liquid absorbing materials, sound absorbing bodies, buffer materials, mats, and corrugated cardboard.

The content of the cellulose fibers in the buffer sheet 1A is preferably 63.0% by mass or greater and 90.0% by mass or less, more preferably 67.0% by mass or greater and 88.0% by mass or less, and still more preferably 72.0% by mass or greater and 86.0% by mass or less.

In this manner, the strength and the buffering performance of the buffer material WS can be further improved.

The buffer sheet 1A contains a binding material.

The binding material has a function of binding a cellulose fiber to a cellulose fiber and may further have other functions. More specifically, the binding material may have a function of suppressing a component other than the cellulose fibers, for example, a colorant or the like described below from falling off from the buffer material.

It is preferable that the binding material have thermal plasticity.

In this manner, the binding material is melted or softened by applying heat in the process of producing the buffer material to spread between cellulose fibers, and thus the cellulose fibers are likely to be bound to each other.

The binding material is melted or softened preferably at 200° C. or lower and more preferably at 160° C. or lower.

In this manner, the cellulose fibers can be more suitably bound to each other by carrying out a heat treatment at a relatively low temperature, which is more preferable from the viewpoint of energy saving.

The glass transition temperature of the binding material is preferably 45° C. or higher and 95° C. or lower and more preferably 50° C. or higher and 90° C. or lower.

In this manner, the cellulose fibers can be more suitably bound to each other by carrying out a heat treatment at a relatively low temperature, which is more preferable from the viewpoint of energy saving. Further, for example, it is possible to effectively prevent the natural binding material from being unexpectedly softened when the buffer material stands in a high temperature environment.

The binding material may be a petroleum-based binding material derived from petroleum or a natural binding material derived from the nature.

Examples of the petroleum-based binding material include various synthetic resins such as thermoplastic resins, thermosetting resins, and photocuring resins.

Examples of the thermoplastic resins among the synthetic resins include an AS resin, an ABS resin, polypropylene, polyethylene, polyvinyl chloride, polystyrene, an acrylic resin, a polyester resin, polyethylene terephthalate, polyphenylene ether, polybutylene terephthalate, nylon, polyamide, polycarbonate, polyacetal, polyphenylene sulfide, and polyether ether ketone.

Among the synthetic resins, biodegradable resins such as polylactic acid, polybutylene succinate, and polyhydroxybutanoic acid may be used as the binding materials other than the natural binding material.

The environmental suitability of the buffer material can be further improved by using the biodegradable resins.

Further, the resins may be, for example, copolymerized or modified.

Examples of the natural binding material include natural resins such as rosin, dammar, mastic, copal, amber, a shellac resin, dragon tree, sandarac, and colophonium, starch which is a natural polymer, and modified products thereof, and one or two or more selected from among these can be used in combination, but it is preferable that the natural binding material contain a shellac resin.

In this manner, the strength and the buffering performance of the buffer material WS can be further improved, and the workability of the buffer material WS can also be further improved.

The starch is a polymer material obtained by polymerizing a plurality of a-glucose molecules with glycoside bonds. The starch may be linear or branched.

For example, starch derived from various plants can be used as the starch. Examples of raw materials of starch include cereals such as corn, wheat, and rice, beans such as broad beans, mung beans, and adzuki beans, tubers such as potatoes, sweet potatoes, and tapioca, wild grasses such as dogtooth violet, bracken, and kadzu, and palms such as sago palm.

For example, processed starch or modified starch may be used as the starch. Examples of the processed starch include acetylated adipic acid crosslinked starch, acetylated starch, oxidized starch, sodium octenyl succinate starch, hydroxypropyl starch, hydroxypropylated phosphoric acid crosslinked starch, phosphorylated starch, phosphoric acid monoesterified phosphoric acid crosslinked starch, urea phosphorylated esterified starch, sodium starch glycolate, and high amylose cornstarch. Further, examples of the modified starch include pregelatinized starch, dextrin, laurylpolyglucose, cationized starch, thermoplastic starch, and carbamic acid starch.

The content of the binding material in the buffer sheet 1A is preferably 12.0% by mass or greater and 28.0% by mass or less, more preferably 14.0% by mass or greater and 25.0% by mass or less, and still more preferably 15.0% by mass or greater and 22.0% by mass or less.

In this manner, the above-described effects are more significantly exhibited.

The buffer sheet 1A is not limited as long as the buffer sheet 1A contains the cellulose fibers and the binding material, but may further contain other components in addition the above-described components. Hereinafter, such components will also be referred to as “other components”.

Examples of other components include a flame retardant, a colorant, an aggregation inhibitor, a surfactant, a fungicide, a preservative, an antioxidant, an ultraviolet absorbing agent, and an oxygen absorbing agent.

The content of other components in the buffer sheet 1A is preferably 7.0% by mass or less, more preferably 5.0% by mass or less, and still more preferably 3.0% by mass or less.

As shown in FIG. 2, the buffer sheet 1A has a sheet shape as a whole. The thickness of the buffer sheet 1A is not particularly limited, but is preferably 0.1 mm or greater and 10 mm or less, more preferably 0.1 mm or greater and 8 mm or less, and still more preferably 0.2 mm or greater and 5 mm or less.

In this manner, the strength and the rigidity of the buffer material WS can be further improved. Further, for example, the workability when the sheet-like buffer material WS is processed into a buffer material WS having a three-dimensional shape by carrying out a process of deep drawing or the like can be further improved, and occurrence of wrinkles or breakage can be more effectively prevented.

The buffer sheet 1A has a plurality of first projections 11A protruding toward one surface side which is the upper surface side in the configuration shown in the figure and a plurality of second projections 12A protruding one surface 21 side.

The first projections 11A are provided in a lattice shape. Further, the first projections 11A are provided in a rectangular shape in plan view of the buffer sheet 1A. In other words, it can be said that the buffer sheet 1A is provided with grooves in a lattice shape. With such a configuration, when the buffer material WS is bent or rolled, the buffer material WS can be similarly deformed regardless of which direction the buffer material WS is bent or rolled. Further, the first projections 11A are first brought into contact with the object to be protected and can be preferentially deformed as compared with a buffer material having a flat surface without the first projections 11A. Therefore, the impact applied from the object to be protected can be absorbed in stages. As a result, the buffering performance is improved. As described above, the buffering performance can be enhanced while the degree of freedom during deformation is ensured, by allowing the buffer material to have the first projections 11A.

The length (maximum length) of a side of the first projection 11A in plan view is preferably 0.1 mm or greater and 5 mm or less and more preferably 0.2 mm or greater and 3 mm or less.

In this manner, when the buffer material WS is bent or rolled, it is possible to prevent the operation from being hindered.

The projection amount (maximum projection amount) of the first projection 11A is preferably 0.1 mm or greater and 5 mm or less and more preferably 0.2 mm or greater and 3 mm or less.

In this manner, the buffering performance can be sufficiently exhibited, and it is possible to prevent the operation from being hindered when the buffer material WS is bent or rolled.

Further, the buffer sheet 1A further has a plurality of second projections 12A with a projection amount greater than that of the first projections 11A. Since the buffer sheet 1A is provided with the second projections 12A, the second projections 12A and the first projections 11A are sequentially brought into contact with the object to be protected and can be deformed. Therefore, the impact applied from the object to be protected can be absorbed in multiple stages. As a result, the buffering performance is further improved.

Further, the second projections 12A have a semispherical shape. Therefore, the buffering performance can be further enhanced, and it is possible to more effectively prevent the operation from being hindered when the buffer material WS is bent or rolled.

The diameter (maximum length) of the second projection 12A in plan view is preferably 0.4 mm or greater and 20 mm or less and more preferably 2 mm or greater and 10 mm or less.

In this manner, when the buffer material WS is bent or rolled, it is possible to prevent the operation thereof from being hindered.

The projection amount (maximum projection amount) of the second projection 12A is preferably 0.2 mm or greater and 10 mm or less and more preferably 1 mm or greater and 5 mm or less.

In this manner, the buffering performance can be sufficiently exhibited, and it is possible to prevent the operation from being hindered when the buffer material WS is bent or rolled.

Further, the maximum projection amount of the second projection 12A is preferably 1.1 times or greater and 8 times of less and more preferably 1.5 times or greater and 4 times or less the maximum projection amount of the first projection 11A. In this manner, the buffering performance can be further enhanced, and it is possible to more effectively prevent the operation from being hindered when the buffer material WS is bent or rolled.

The density of the buffer sheet 1A is not particularly limited, but is preferably 0.02 g/cm³ or greater and 0.20 g/cm³ or less, more preferably 0.03 g/cm³ or greater and 0.15 g/cm³ or less, and still more preferably 0.05 g/cm³ or greater and 0.11 g/cm³ or less.

In this manner, the strength and the rigidity of the buffer material WS can be further improved. Further, the durability of the buffer material WS against an impact can be further improved. Further, for example, the workability when the buffer material WS is processed into a buffer material WS having a three-dimensional shape by carrying out a process of deep drawing or the like can be further improved, and occurrence of wrinkles or breakage can be more effectively prevented.

Particularly, when the buffer material WS satisfies the above-described conditions for the thickness and the above-described conditions for the density, the effects obtained by satisfying the conditions are synergistically enhanced so that the above-described effects are more significantly exhibited.

The basis weight of the cellulose fibers in the buffer sheet 1A is not particularly limited, but is preferably 150 g/m² or greater and 650 g/m² or less, more preferably 160 g/m² or greater and 600 g/m² or less, and still more preferably 200 g/m² or greater and 500 g/m² or less. In this manner, the strength and the rigidity of the buffer material WS can be further improved. Further, the durability of the buffer material against an impact can be further improved. Further, for example, the workability when the sheet-like buffer material WS is processed into a buffer material WS having a three-dimensional shape by carrying out a process of deep drawing or the like can be further improved, and occurrence of wrinkles or breakage can be more effectively prevented.

As described above, the buffer material WS includes a buffer sheet that contains cellulose fibers and a binding material binding the cellulose fibers and has a sheet shape. Further, the buffer sheet 1A has a plurality of the first projections 11A that protrude toward at least one surface side and are provided in a lattice shape. In this manner, when the buffer material WS is bent or rolled, the buffer material WS can be similarly deformed regardless of which direction the buffer material WS is bent or rolled. Further, the first projections 11A are first brought into contact with the object to be protected and can be preferentially deformed as compared with a buffer material having a flat surface without the first projections 11A. Therefore, the impact applied from the object to be protected can be absorbed in stages. As a result, the buffering performance is improved. As described above, the buffering performance can be enhanced while the degree of freedom during deformation is ensured, by allowing the buffer material to have the first projections 11A.

Further, the first projections 11A have a rectangular shape in plan view of the buffer sheet 1A. In this manner, the buffer sheet 1A can be easily produced, and the buffering performance can be further enhanced.

Further, the shape of the first projection 11A in plan view is not particularly limited, and the first projection 11A may have, for example, a triangular or pentagonal or higher polygonal shape or a circular shape.

Further, the shape of the second projection 12A in plan view is not particularly limited, and the second projection 12A may have, for example, a triangular shape, a rectangular shape, or a pentagonal or higher polygonal shape.

### Production Device

Next, a production device that can be used for production of the buffer material WS will be described.

FIG. 1 is a view schematically showing an example of a production device capable of producing the buffer material WS.

As shown in FIG. 1, a production device 100 includes a supply unit 10, a crushing unit 12, a defibrating unit 20, a sorting unit 40, a first web forming unit 45, a rotating body 49, a mixing unit 50, an accumulating unit 60, a second web forming unit 70, a buffer material forming unit 80, a cutting unit 90, and a humidifying unit 78.

The supply unit 10 supplies the raw material to the crushing unit 12. The supply unit 10 is an automatic charging unit for continuously charging the crushing unit 12 with the raw material. The raw material to be supplied to the crushing unit 12 may contain the cellulose fibers.

The crushing unit 12 cuts the raw material supplied by the supply unit 10 in the atmosphere, for example, in the air to form small pieces. As the shape and the size of the small pieces, small pieces with a size of several cm square may be exemplified. In the example shown in the figure, the crushing unit 12 includes crushing blades 14, and the raw material added to the crushing unit 12 can be cut by the crushing blades 14. For example, a shredder is used as the crushing unit 12. The raw material cut by the crushing unit 12 is received by a hopper 1 and transported to the defibrating unit 20 through a pipe 2.

The defibrating unit 20 defibrates the raw material cut by the crushing unit 12. Here, the term “defibrate” denotes that the raw material formed by binding a plurality of cellulose fibers, that is, a material to be defibrated is loosened into individual cellulose fibers. The defibrating unit 20 also has a function of separating substances, such as resin particles, an ink, a toner, a filler, and a bleeding inhibitor, adhering to the raw material from the cellulose fibers.

The material having passed through the defibrating unit 20 is referred to as “defibrated material”. In some cases, “defibrated material” contains, in addition to the loosened cellulose fibers, resin particles separated from the cellulose fibers during loosening of the cellulose fibers, a coloring agent such as an ink, a toner, or a filler, and an additive such as a bleeding inhibitor or a paper strength enhancer. Examples of the resin particles separated from the cellulose fibers include particles containing a resin for binding a plurality of cellulose fibers.

The defibrating unit 20 performs dry type defibration. A treatment of performing defibration or the like in the atmosphere, for example, in the air without performing wet type defibration of dissolving a material in a liquid such as water in a slurry form is referred to as dry type defibration. In the present embodiment, an impeller mill is used as the defibrating unit 20. The defibrating unit 20 has a function of generating an air flow that sucks the raw material and discharges the defibrated material. In this manner, the defibrating unit 20 can suck the raw material from an introduction port 22 together with the air flow, perform the defibration treatment, and transport the defibrated material to a discharge port 24 by the air flow generated by itself. The defibrated material that has passed through the defibrating unit 20 is transferred to the sorting unit 40 through the pipe 3. Further, as the air flow for transporting the defibrated material to the sorting unit 40 from the defibrating unit 20, the air flow generated by the defibrating unit 20 may be used or an airflow generating device such as a blower is provided and an air flow generated by the device may be used.

The sorting unit 40 introduces the defibrated material defibrated by the defibrating unit 20 from the introduction port 42 and sorts out the defibrated material according to the length of the cellulose fibers. The sorting unit 40 includes a drum portion 41 and a housing unit 43 that accommodates the drum portion 41. For example, a sieve is used as the drum portion 41. The drum portion 41 has a net and can divide the defibrated material into a first sorted material that is cellulose fibers or particles having a size smaller than the size of the mesh of the net and thus passing through the net and a second sorted material that is cellulose fibers, undefibrated pieces, or lumps having a size greater than the size of the mesh of the net and thus not passing through the net. For example, the first sorted material is transferred to the mixing unit 50 through the pipe 7. The second sorted material is returned to the defibrating unit 20 from a discharge port 44 through a pipe 8. Specifically, the drum portion 41 is a cylindrical sieve rotationally driven by a motor. As the net of the drum portion 41, for example, a wire net, an expanded metal obtained by expanding a metal plate with cuts, or a punching metal in which holes are formed in a metal plate with a press machine or the like is used.

The first web forming unit 45 transports the first sorted material having passed through the sorting unit 40 to the mixing unit 50. The first web forming unit 45 includes a mesh belt 46, a stretching roller 47, and a suction unit 48.

The suction unit 48 can suck the first sorted material having passed through the opening of the sorting unit 40, that is, the opening of the net and dispersed in the air, onto the mesh belt 46. The first sorted material is accumulated on the moving mesh belt 46 to form a web V. The basic configurations of the mesh belt 46, the stretching roller 47, and the suction unit 48 are the same as the configurations of a mesh belt 72, a stretching roller 74, and a suction mechanism 76 of the second web forming unit 70 described below.

The web V passes through the sorting unit 40 and the first web forming unit 45 and is thus formed in a soft and inflated state due to containing a large amount of air. The pipe 7 is charged with the web V accumulated on the mesh belt 46, and the web V is transported to the mixing unit 50.

The rotating body 49 can cut the web V before the web V is transported to the mixing unit 50. In the example shown in the figure, the rotating body 49 includes a base portion 49a and protrusions 49b protruding from the base portion 49a. The protrusions 49b have, for example, a plate shape. In the example shown in the figure, four protrusions 49b are provided and the four protrusions 49b are provided at equal intervals. Since the base portion 49a rotates in a direction R, the protrusions 49b can rotate using the base portion 49a as an axis. Since the web V is cut by the rotating body 49, for example, a fluctuation in amount of the defibrated material supplied to the accumulating unit 60 per unit time can be reduced.

The rotating body 49 is provided in the vicinity of the first web forming unit 45. In the example shown in the figure, the rotating body 49 is provided in the vicinity of the stretching roller 47a positioned on the downstream in the path of the web V, that is, next to the stretching roller 47a. The rotating body 49 is provided at a position where the protrusions 49b can come into contact with the web V and does not come into contact with the mesh belt 46 on which the web V is accumulated. The shortest distance between the protrusions 49b and the mesh belt 46 is, for example, 0.05 mm or greater and 0.5 mm or less.

The mixing unit 50 mixes the first sorted material having passed through the sorting unit 40, that is, the first sorted material transported by the first web forming unit 45 with an additive containing the natural binding material. The mixing unit 50 includes an additive supply unit 52 that supplies the additive, a pipe 54 that transports the first sorted material and the additive, and a blower 56. In the example shown in the figure, the additive is supplied to the pipe 54 through the hopper 9 from the additive supply unit 52. The pipe 54 is connected to the pipe 7.

The mixing unit 50 allows the blower 56 to generate an air flow so that the first sorted material and the additive can be transported while being mixed with each other in the pipe 54. Further, the mechanism of mixing the first sorted material and the additive is not particularly limited, and the first sorted material and the additive may be mixed by being stirred using a blade rotating at a high speed or may be mixed by using rotation of a container as in a case of a V type mixer.

A screw feeder as shown in FIG. 1 or a disc feeder which is not shown in the figure is used as the additive supply unit 52. The additive supplied from the additive supply unit 52 contains the above-described natural binding material. The plurality of cellulose fibers have not been bound at the time point when the natural binding material is supplied. The natural binding material is partially melted while passing through the buffer material forming unit 80 so that the plurality of cellulose fibers in the surface region of the buffer material WS are bound.

Further, the additive to be supplied from the additive supply unit 52 may contain, in addition to the natural binding material, a colorant for coloring the cellulose fibers, an aggregation inhibitor for suppressing aggregation of the cellulose fibers or aggregation of the natural binding material, and a flame retardant for making the cellulose fibers and the like difficult to burn, depending on the type of the buffer material WS to be produced. The composition for producing a buffer material which is the mixture having passed through the mixing unit 50, that is, the mixture of the first sorted material and the additive is transferred to the accumulating unit 60 through the pipe 54.

The accumulating unit 60 introduces the mixture having passed through the mixing unit 50 from the introduction port 62, loosens the defibrated material of the entangled cellulose fibers, and drops the mixture while dispersing the mixture in the air. In this manner, the accumulating unit 60 can uniformly accumulate the mixture on the second web forming unit 70.

The accumulating unit 60 includes a drum portion 61 and a housing unit 63 that accommodates the drum portion 61. A cylindrical rotating sieve is used as the drum portion 61. The drum portion 61 has a net and drops the cellulose fibers or particles which are contained in the mixture having passed through the mixing unit 50 and have a size smaller than the size of the mesh of the net. The configuration of the drum portion 61 is the same as the configuration of the drum portion 41.

Further, “sieve” of the drum portion 61 may not have a function of sorting out a specific object. That is, “sieve” used as the drum portion 61 denotes a portion provided with a net, and the drum portion 61 may drop the entire mixture introduced to the drum portion 61. The second web forming unit 70 accumulates the material having passed through the accumulating unit 60 to form a web W which is an accumulated material serving as the buffer material WS. Here, a molding die which is not shown in FIG. 1 is placed on the mesh belt 72 to be used as a saucer so that a web can be formed in the molding die. The second web forming unit 70 includes the mesh belt 72, the stretching roller 74, and the suction mechanism 76. For example, a molding die having a shape corresponding to the shape of the buffer sheet 1A shown in FIGS. 2 and 3 can be used as the molding die.

The mesh belt 72 accumulates the material having passed through the opening of the accumulating unit 60, that is, the opening of the net on the molding die while moving. The mesh belt 72 and the molding die are configured to be stretched by the stretching roller 74 and circulate the air to make the material having passed through the accumulating unit difficult to pass through. The mesh belt 72 moves by rotation of the stretching roller 74. The mesh belt 72 continuously drops and accumulates the material having passed through the accumulating unit 60 while continuously moving, and thus the web W is formed on the molding die provided on the mesh belt 72. The mesh belt 72 and the molding die are made of, for example, a metal, a resin, cloth, or nonwoven fabric.

The suction mechanism 76 is provided below the mesh belt 72, that is, on a side opposite to the side of the accumulating unit 60. The suction mechanism 76 can generate an air flow flowing downward, that is, an air flow flowing to the mesh belt 72 from the accumulating unit 60. The mixture dispersed in the air by the accumulating unit 60 can be sucked onto the mesh belt 72 by the suction mechanism 76. In this manner, the discharge rate of the material from the accumulating unit 60 can be increased. Further, the suction mechanism 76 can form a downflow in the path where the mixture falls, and thus it is possible to suppress the defibrated material and the additive from being entangled with each other during the fall.

As described above, the web W is formed in a soft and inflated state due to containing a large amount of air by carrying out the web forming step performed by the accumulating unit 60 and the second web forming unit 70. The web W accumulated on the molding die provided on the mesh belt 72 is transported to the buffer material forming unit 80.

The thickness of the web W which is the accumulated material to be transported to the buffer material forming unit 80 is preferably 2.0 mm or greater and 150 mm or less, more preferably 3.0 mm or greater and 120 mm or less, and still more preferably 5.0 mm or greater and 100 mm or less.

Further, the density of the web W is preferably 0.01 g/cm³ or greater and 0.05 g/cm³ or less and more preferably 0.02 g/cm³ or greater and 0.04 g/cm³ or less.

Further, the basis weight of the web W is preferably 150 g/m² or greater and 650 g/m² or less, more preferably 160 g/m² or greater and 600 g/m² or less, and still more preferably 200 g/m² or greater and 500 g/m² or less.

The buffer material forming unit 80 includes a support portion 81 and a die 82. A heater is built in at least one of the support portion 81 or the die 82. The support portion 81 is formed of a member having a flat plate shape. The die 82 is provided on a side opposite to the support portion 81 via the web W during the transport.

The die 82 can be in a state where the die 82 is pushed against the support portion 81 so that the web W is heated and pressed or a state where the die 82 is separated from the support portion 81.

In the present embodiment, the buffer material WS can be produced by repeatedly performing a process of intermittently transporting the web W, allowing the support portion 81 and the die 82 to enter the state where the web W is heated and pressed, and releasing the state.

Further, the support portion 81 may be of a male type corresponding to the shape of the first projections 11A and the second projections 12A. In this case, the first projections 11A and the second projections 12A can be formed on both surfaces of the buffer sheet 1A.

Further, the configuration is not limited to the configuration described above, and the web W may be heated and pressed by, for example, using a pair of heating and pressing rollers on which unevenness corresponding to the shape of the first projections 11A and the second projections 12A is formed. In this case, the buffer material WS can be produced while the web is continuously transported. Therefore, the productivity is excellent.

When a binding material having a melting point or a softening point is used, the heating temperature in the present step is preferably higher than the melting point or the softening point by 10° C. or higher and 250° C. or lower and more preferably higher than the melting point or the softening point by 20° C. or higher and 220° C. or lower. When the binding material is starch or the like, the heating temperature is preferably 50° C. or higher and lower than 100° C. of the temperature at which moisture (30% by mass or less) is added to the binding material to start gelatinization.

In this manner, the natural binding material can efficiently form binding of the cellulose fibers while unexpected modification, deterioration, or the like of the constituent components of the buffer sheet 1A is effectively prevented, the productivity of the buffer sheet 1A can be further improved, and the strength, the buffering performance, and the like of the buffer sheet 1A can be further improved. Further, it is also preferable that the heating temperature be in the above-described ranges even from the viewpoint of energy saving.

Further, the pressing pressure in the present step is preferably 0.50 MPa or less, more preferably 0.01 MPa or greater and 0.45 MPa or less, and still more preferably 0.03 MPa or greater and 0.40 MPa or less.

In this manner, the natural binding material can efficiently form binding of the cellulose fibers while the buffer sheet 1A to be produced is allowed to have a moderate amount of voids, and thus the strength, the buffering performance, and the like of the buffer sheet 1A can be further improved. Further, it is also preferable that the pressing pressure be in the above-described ranges even from the viewpoint of energy saving.

The heating and pressing time in the present step is preferably 1 second or longer and 300 seconds or shorter, more preferably 10 seconds or longer and 60 seconds or shorter, and still more preferably 15 seconds or longer and 45 seconds or shorter.

In this manner, the productivity of the buffer material WS can be further improved, and the strength, the buffering performance, and the like of the buffer material WS can be further improved. It is also preferable that the heating and pressing time be in the above-described ranges even from the viewpoint of energy saving.

The production device 100 of the present embodiment may include the cutting unit 90 as necessary. In the example shown in the figure, the cutting unit 90 is provided on the downstream of the buffer material forming unit 80. The cutting unit 90 cuts the molding die containing the buffer material WS molded by the buffer material forming unit 80. In the example shown in the figure, the cutting unit 90 includes a first cutting unit 92 cutting the molding die of the buffer material WS in a direction intersecting the transport direction of the buffer material WS and a second cutting unit 94 cutting the buffer material WS in a direction parallel to the transport direction. The second cutting unit 94 cuts, for example, the molding die containing the buffer material WS having passed through the first cutting unit 92.

Further, the production device 100 of the present embodiment may include the humidifying unit 78. In the example shown in the figure, the humidifying unit 78 is provided on the downstream of the cutting unit 90 and on the upstream of a discharge unit 96. The humidifying unit 78 is capable of applying water or water vapor to the buffer material WS. Specific examples of the aspect of the humidifying unit 78 include an aspect of spraying mist of water or an aqueous solution, an aspect of spraying water or an aqueous solution, and an aspect of jetting water or an aqueous solution from an ink jet head for adhesion.

Since the production device 100 includes the humidifying unit 78, the buffer material WS to be formed can be humidified. In this manner, the cellulose fibers are humidified and softened. Therefore, when a container or the like is three-dimensionally molded by using the buffer material WS, wrinkles or breakage is less likely to occur. Further, since a hydrogen bond is easily formed between cellulose fibers by humidifying the buffer material WS, the density of the buffer material WS is increased, and for example, the strength can be improved.

In the example of FIG. 1, the humidifying unit 78 is provided on the downstream of the cutting unit 90, and the same effects as described above can be obtained as long as the humidifying unit 78 is provided on the downstream of the buffer material forming unit 80. That is, the humidifying unit 78 may be provided on the downstream of the buffer material forming unit 80 and on the upstream of the cutting unit 90.

The buffer material WS is obtained, for example, as a three-dimensional molded body having a convex shape by demolding only the buffer material WS from the molding die where the buffer material WS has been molded.

### Second Embodiment

FIG. 4 is a cross-sectional view showing the buffer material (second embodiment) of the present disclosure.

Hereinafter, the second embodiment of the buffer material of the present disclosure will be described with reference to the accompanying drawing, but the description will be made mainly on the points different from those in the above-described embodiment and the description of the same points as described above will not be provided.

In the present embodiment, nonwoven fabric sheets 1B are respectively provided on one surface side and the other surface side of the buffer sheet 1A as shown in FIG. 4. The nonwoven fabric sheets 1B are bonded to the buffer sheet 1A.

As described above, the both surfaces of the buffer sheet 1A are covered with the nonwoven fabric sheets, and thus it is possible to prevent or suppress powder of the cellulose fibers or the like of the buffer sheet 1A from being scattered. Therefore, adhesion of powder of the cellulose fibers or the like to an object to be protected can be prevented or suppressed.

The fibers constituting the nonwoven fabric sheet 1B are not particularly limited, but it is preferable that the fibers be the same as the cellulose fibers used in the buffer sheet 1A.

Further, it is preferable that the average length of the fibers constituting the nonwoven fabric sheet 1B be greater than the average length of the cellulose fibers contained in the buffer sheet 1A.

Further, the nonwoven fabric sheet 1B may contain a binding material that binds the fibers. The binding material is not particularly limited and can be appropriately selected from, for example, those exemplified as the binding material contained in the buffer sheet 1A and then used.

The thickness (average thickness) of the nonwoven fabric sheet 1B is not particularly limited, but is preferably 0.05 mm or greater and 1 mm or less and more preferably 0.1 mm or greater and 0.5 mm or less.

In this manner, the first projections 11A and the second projections 12A can sufficiently exhibit the above-described effects. Further, it is possible to more effectively prevent or suppress powder of the cellulose fibers or the like of the buffer sheet 1A from being scattered.

Further, the basis weight of the nonwoven fabric sheet 1B is preferably 10 g/m² or greater and 100 g/m² or less and more preferably 10 g/m² or greater and 50 g/m² or less. In this manner, it is possible to more effectively prevent or suppress powder of the cellulose fibers or the like of the buffer sheet 1A from being scattered and to sufficiently ensure the buffering performance of the buffer sheet 1A.

Hereinbefore, the suitable embodiments of the present disclosure have been described, but the present disclosure is not limited thereto.

For example, the present disclosure has configurations that are substantially the same as the configurations described in the embodiments, for example, configurations with the same functions, the same methods, and the same results as described above or configurations with the same purposes and the same effects as described above. Further, the present disclosure has configurations in which parts that are not essential in the configurations described in the embodiments have been substituted. Further, the present disclosure has configurations exhibiting the same effects as the effects of the configurations described in the embodiments or configurations capable of achieving the same purposes as the purposes of the configurations described in the embodiments. Further, the present disclosure has configurations in which known techniques have been added to the configurations described in the embodiments.

For example, the buffer material of the present disclosure is not limited to the buffer material produced by the above-described method using the above-described production device.

What is claimed is:

1. A buffer material comprising:
a buffer sheet that contains cellulose fibers and a binding material binding the cellulose fibers and has a sheet shape,
wherein the buffer sheet has a plurality of first projections that protrude toward at least one surface side and are provided in a lattice shape.

2. The buffer material according to claim 1,
wherein the first projections are provided in a rectangular shape in plan view of the buffer sheet.

3. The buffer material according to claim 1,
wherein the buffer sheet further has a plurality of second projections having a projection amount that is greater than a projection amount of the first projections.

4. The buffer material according to claim 3,
wherein the second projections are provided in a semispherical shape.

5. The buffer material according to claim 3,
wherein a maximum projection amount of the second projections is 1.1 times or greater and 8 times or less a maximum projection amount of the first projections.

6. The buffer material according to claim 1,
wherein the cellulose fibers in the buffer sheet have a basis weight of 150 g/m² or greater and 650 g/m² or less.
